(19) United States
(12) Patent Application Publication
(10) Pub. No.: US 2016/0021817 A1
(43) Pub. Date: Jan. 28, 2016

(54) Mower Blade for Optimizing a Lawnmower

(71) Applicant: Raymond Rojas, La Blanca, TX (US)

(72) Inventor: Raymond Rojas, La Blanca, TX (US)

(21) Appl. No.: 14/337,247

(22) Filed: Jul. 22, 2014

(51) Int. Cl. A01D 34/73

(52) U.S. Cl. CPC A01D 34/73

(57) ABSTRACT

An improved mower blade for optimizing a lawnmower is herein disclosed. The mower blade can comprise one or more weighted discs and one or more blades. The weighted discs can comprise a central orifice and a plurality of disc orifices. The blades can comprise a base insert and a plurality of blade orifices. The weighted discs can be attached to one surface of the blades. The blade orifices can be compatible with the disc orifices.

### BACKGROUND

This disclosure relates to an improved mower blade for optimizing a lawnmower.

Lawn mowers are an essential tool in yard maintenance and general landscaping. An effective mower requires a blade propelled by the engine of the lawn mower. Additionally, conventional lawn mowers typically also have a starter system necessary for engaging the engine. Yet, some lawn mowers can be inefficient, as gas consumption may not be optimized with relation to the torque and weight of the blade. As more power is exerted by the lawn mower's engine, more gas is consumed. As a result, conventional lawnmowers may not be able to cut the desired amount of grass in a given time frame or with the least amount of gas. Therefore, there is a need for a mower blade that can provide more force to the lawnmower, to be able to cut greater amount of grass quickly and with less energy consumed, which spares time, effort and money for the user. As such it would be useful to have an improved mower blade for optimizing a lawnmower.

### SUMMARY

An improved mower blade for optimizing a lawnmower is herein disclosed. The improved mower blade can comprise one or more weighted discs and one or more blades. The weighted discs can comprise a central orifice and a plurality of disc orifices. The blades can comprise a base insert and a plurality of blade orifices. The weighted discs can be attached to one surface of the blades. The blade orifices can be compatible with the disc orifices.

A method for optimizing a lawnmower is further disclosed. The method can comprise the steps attaching a weighted disc, and affixing the weighted disc to a surface of a blade. The weighted disc can comprise a central orifice and a plurality of disc orifices. The blade can comprise a base insert and a plurality of blade orifices. The blade orifices compatible with the disc orifices.

### BRIEF DESCRIPTION OF THE DRAWINGS

FIG. 1 illustrates a mower blade shaft comprising one or more blades and one or more weighted discs.

FIG. 2A illustrates an embodiment of blades.

FIG. 2B illustrates another embodiment of blades.

FIG. 3 illustrates a weighted disc comprising a central orifice and a plurality of disc orifices.

FIG. 4A illustrates blades attached to a weighted disc in an X-shape.

FIG. 4B illustrates blades attached to a weighted disc in a Y-shape.

FIG. 4C illustrates blades attached to a weighted disc in an I-shape.

FIG. 5A illustrates how a weighted disc can be attached to blades.

FIG. 5B illustrates an embodiment of a mower blade shaft comprising a plurality of weighted discs attached to blades.

FIG. 6A illustrates a mower blade shaft attached at the bottom of a lawn mower, wherein weighted disc is at the bottom surface of blades.

FIG. 6B illustrates a mower blade shaft attached at the bottom of lawn mower, wherein weighted disc is at the top surface of blades.

### DETAILED DESCRIPTION

Described herein is an improved mower blade for optimizing a lawnmower. The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

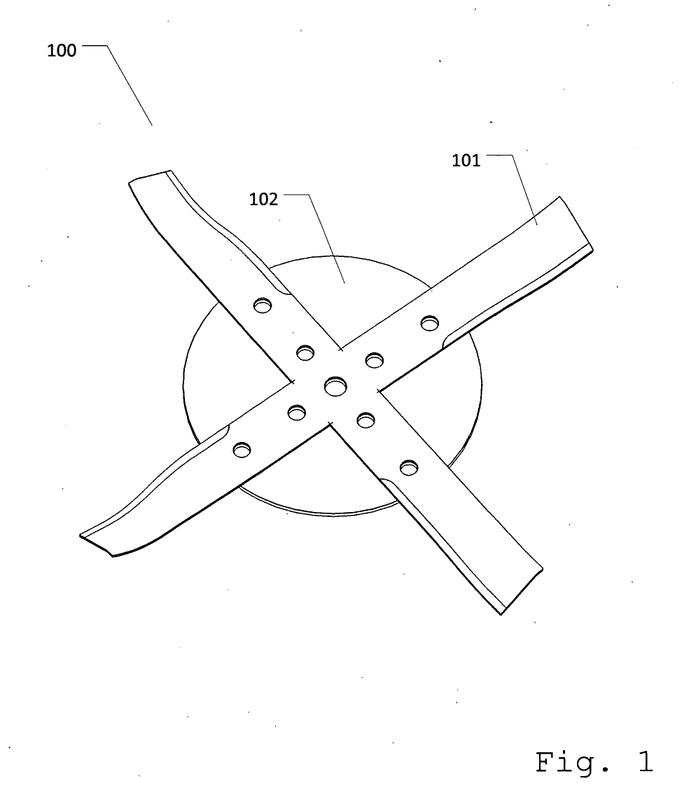

FIG. 1 illustrates a mower blade shaft 100 comprising one or more blades 101 and one or more weighted discs 102. In a preferred embodiment, mower blade shaft 100 can be fitted to a rotor system as a component of a conventional lawn mower motor used to cut the grass, which will be further elaborated upon below. Blades 101 can comprise an angled, sharp edge, which, in one embodiment, can be capable of cutting grass. Weighted discs 102 can be attached to mower blade shaft 100. Weighted discs 102 can provide evenly distributed weight to blades 101 that can add force during propulsion of blades 101, resulting in more cutting power. Furthermore, in one embodiment, blades 101 and weighted discs 102 can be metallic, comprising materials that can include, but are not limited to, iron, steel or some mixture of metallic composites.

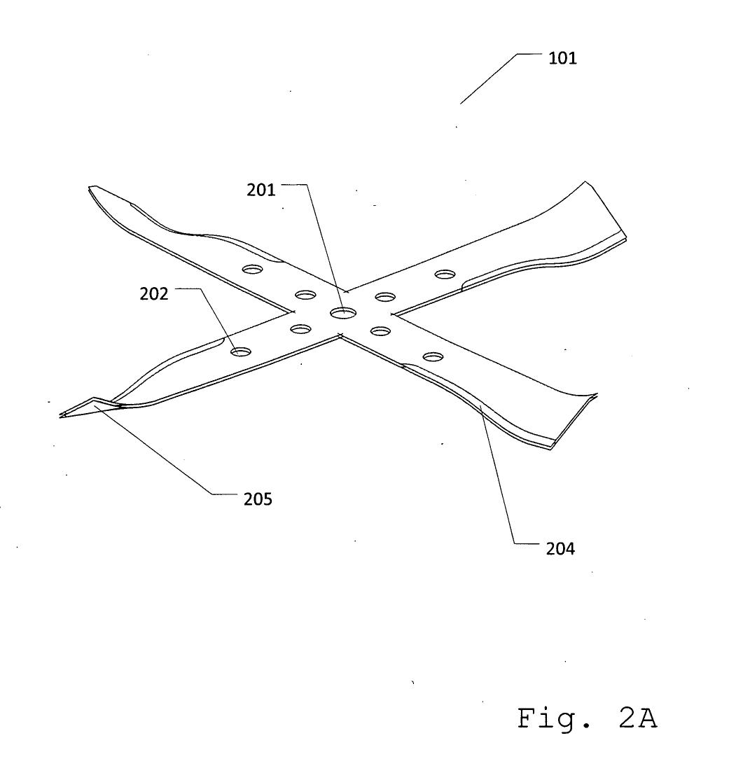

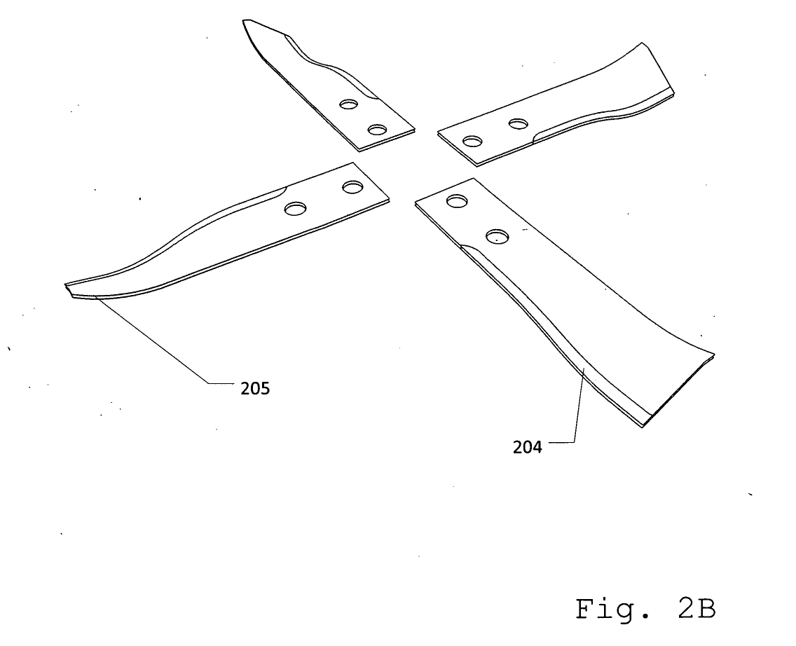

FIG. 2A illustrates an embodiment of blades 101. In one embodiment, blades 101 can be unibody. In this embodiment, blades 101 can be permanently attached together through any adhesive material or through binding method such as soldering, or molding. As such, blades 101 can be a unibody. Furthermore, in this embodiment, blades 101 can comprise a base insert 201 and a plurality of blade orifices 202. Base insert 201 can be a circular opening at the center of blades 101. Blade orifices 202 can be a plurality of opening along the body of blades 201.

FIG. 2B illustrates another embodiment of blades 101. In this embodiment, blades 101 can be a plurality of separate devices that can be individually mounted to weighted discs 102. In such embodiments, each blade 101 can comprise a cutting edge 204 and an elevation 205. Cutting edge 204 can be the sharp portion of blades 101 that is placed at one side extending from the tip to the middle portion of blades 101. Elevation 205 can be a bend curving upward that is positioned at the opposite side of cutting edges 204. In such configuration, blades 101 can have a plurality of cutting points that can aid in cutting more grass at lesser time.

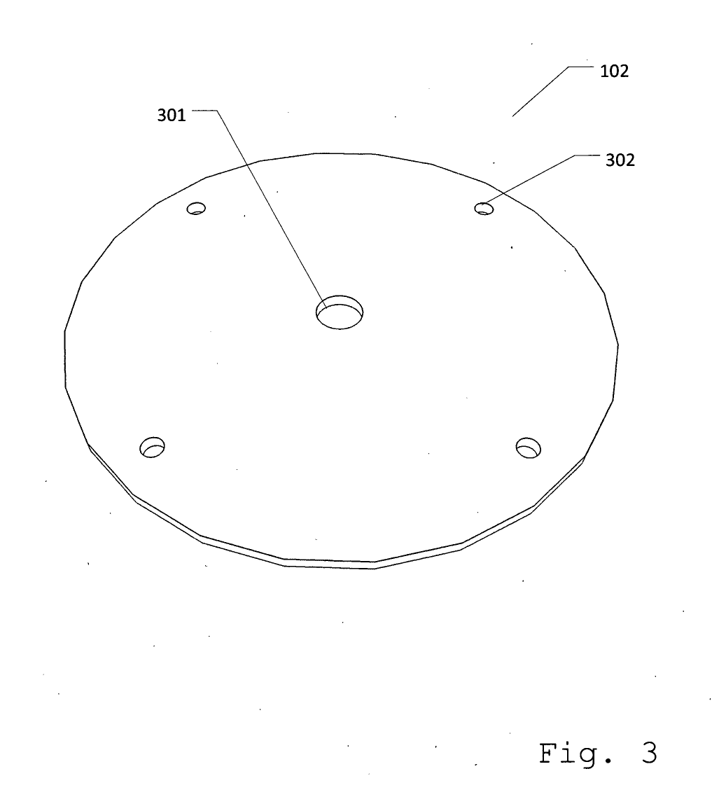

FIG. 3 illustrates a weighted disc 102 comprising a central orifice 301 and a plurality of disc orifices 302. Central orifice 301 can be an opening at the center of weighted disc 102. Central orifice 301 can have the same diameter with base insert 201. Disc orifices 302 can have similar diameter with base inserts 202. Furthermore, disc orifices 302 can be configured to be compatible with base inserts 202 allowing disc orifices 302 be mateable with base inserts 202 through a fastening device.

Additionally, weighted disc 102 can vary in sizes, dimension, and shape. Moreover, in an embodiment wherein disc 102 can be attached to blade 101 through a fastening device, weighted disc 102 can have various diameters. In one embodiment, weighted disc 102 can have a large diameter. In such embodiments, blade orifices 202 on blades 101 can be compatible with disc orifices 302 of disc 102. As such, a fastening device can be insertable on disc orifices 302 and blade orifices 202 attaching weighted discs 102 and blades 101 together.

Furthermore, in one embodiment, weighted disc 102 can be used as individual device that adds weight to blades 101. In one embodiment, a weighted disc 102 can be attached to either surface of mower blade shaft 100. In such embodiment, weighted disc 102 can have varying thickness with an increment of ⅛ inch, ¼ inch, ½ inch, etc. In various embodiments, a plurality of weighted discs 102 can be attached to mower blade shaft 100. In various embodiments, a weighted disc 102 can be attached to either surface of mower blade shaft 100. In another embodiment, at least two weighted discs 102 may sandwich mower blade shaft 100 on both surfaces of mower blade shaft 100.

In another embodiment, a plurality of weighted discs 102 can be stacked and attached to blades 101. In such embodiment, weighted discs 102 can have ⅛ th inch thickness to allow at least two or more weighted discs 102 to be stacked together providing desired weight to blades 101. In such configuration, weighted disc 102 can provide more cutting power to a lawn mower. Weighted disc 102 can provide more force to blades 101 that can increase the velocity of the motor of lawnmower would need to exert. In such embodiments, the motor in lawnmower can be at least 6 hp (Horsepower).

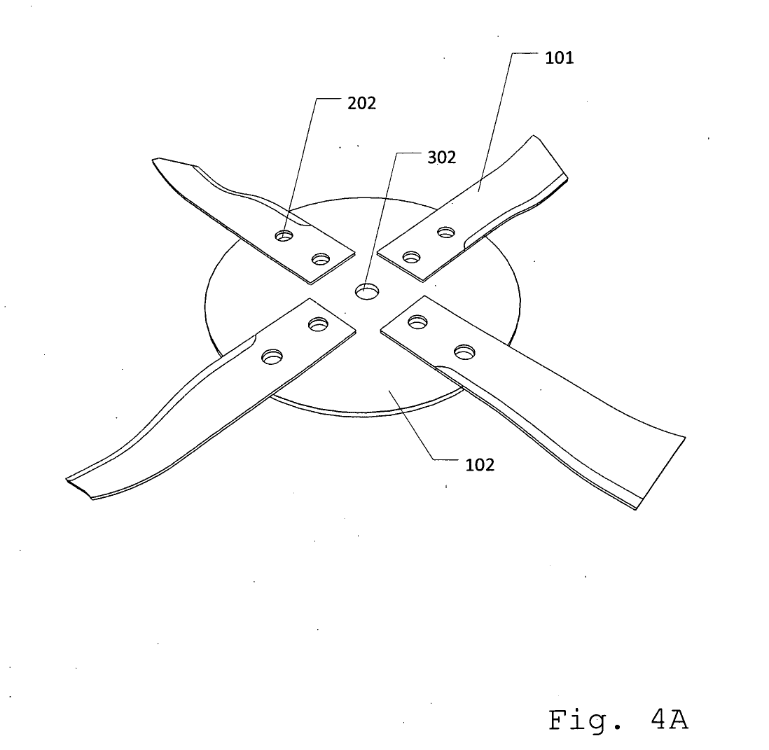

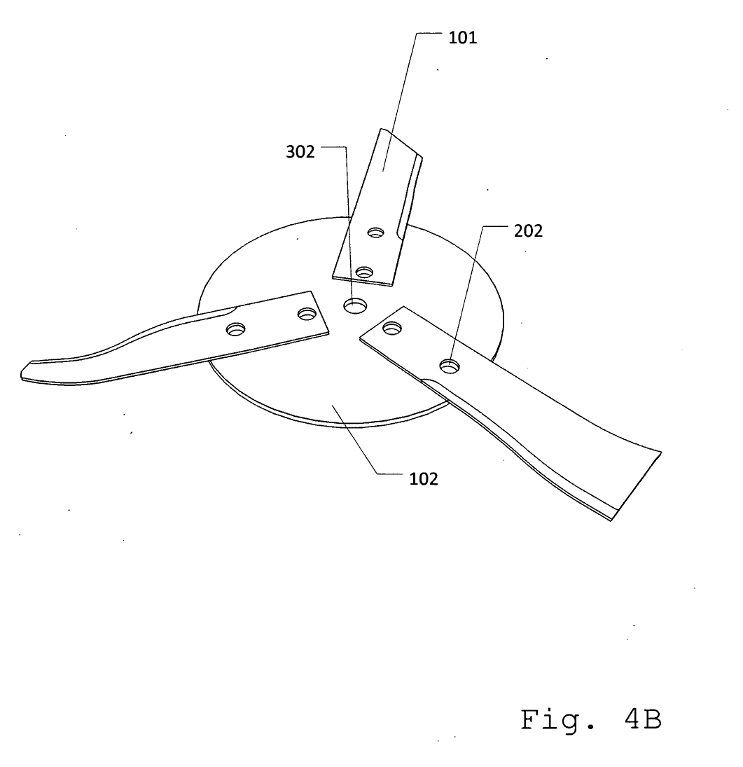

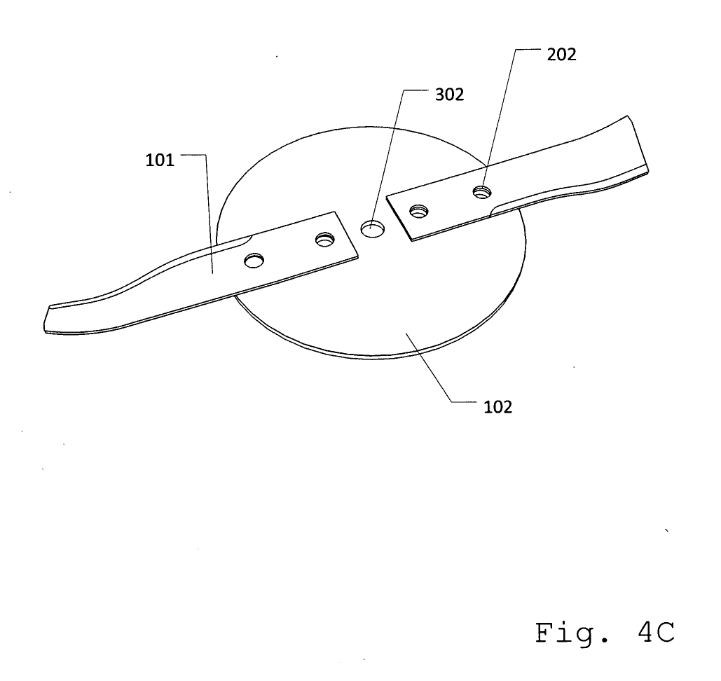

FIG. 4A illustrates blades 101 attached to weighted disc 102 in an X-shape. Thus, in an embodiment where blades 101 can be separate devices, at least four blades 101 can be attached near the edges of weighted disc 102. As such, blades 101 can extend from weighted disc 102 forming an X-shape. Furthermore, in an embodiment where blades 101 can be single device, blades 101 can be configured in X-shape. As such, blades 101 can be attached to weighted disc 102 as a single device. In these embodiments, disc orifices 302 can be positioned in weighted disc 102 in an X-shape, to allow blade orifices 202 to be compatible with disc orifices 302.

FIG. 4B illustrates blades 101 attached to weighted disc 102 in a Y-shape. In an embodiment wherein blades 101 can be separate devices, at least three blades 101 can extend from weighted disc 102. In this embodiment, blades 101 can be positioned on a surface of weighted disc 102 forming a Y-shape. In an embodiment where blades 101 can be unibody, blades 101 can be configured into a Y-shape. As such, blades 101 can be attached to weighted disc 102 as a single device. In such embodiments, disc orifices 302 can be positioned in weighted disc 102 forming a y-shape. Thus, allowing blade orifices 202 compatible with disc orifices 302.

FIG. 4C illustrates blades 101 attached to weighted disc 102 in an I-shape. In an embodiment wherein blades 101 can be separate devices, at least two blades 101 can be positioned on a surface of weighted disc 102 forming an I-shape. In another embodiment where blades 101 can be unibody, blades 101 can be configured in I-shape. As such, blades 101 can be attached to weighted disc 102 as a single device. In such embodiments, disc orifices 302 can be positioned in weighted disc 102 forming an I-shape. Thus, allowing blade orifices 202 compatible with disc orifices 302.

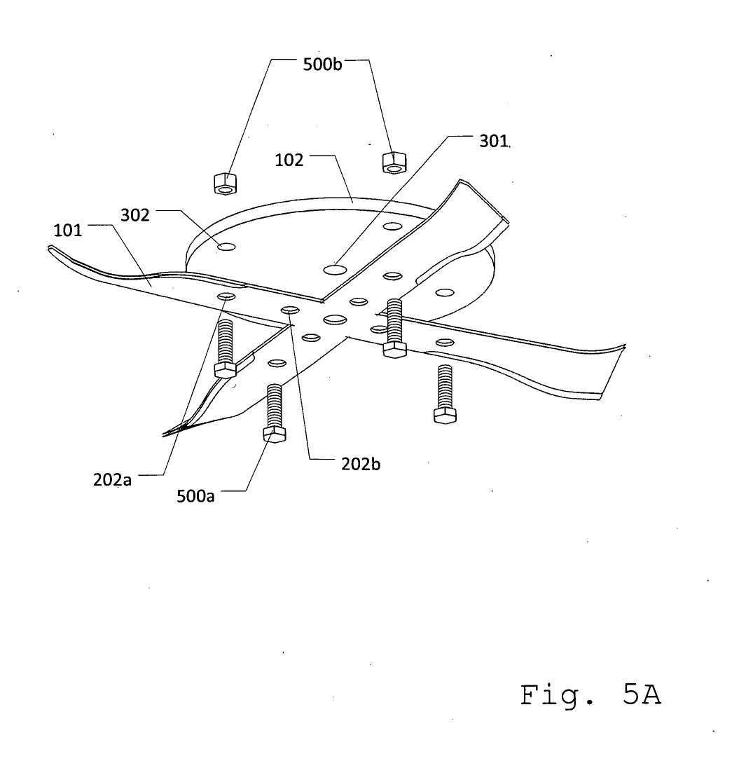

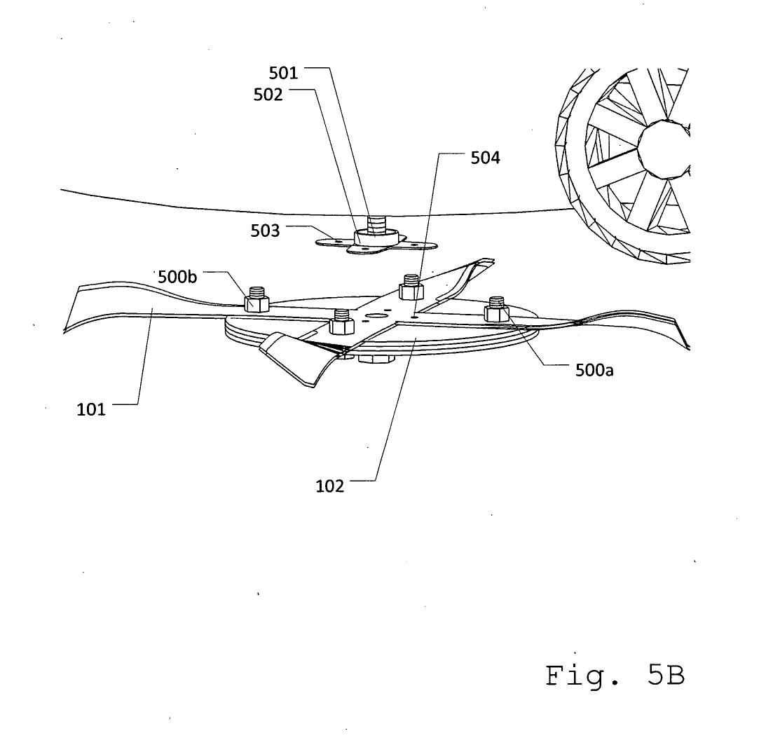

FIG. 5A illustrates how weighted disc 102 can be attached to blades 101. In one embodiment, blades 101 can be fastened to weighted disc 102 through the use of a fastening device 500a. Fastening device 500a can include but are not limited to screws, nuts, and bolts. Blades 101 can be positioned on a surface of weighted disc 102 aligning blade orifices 202 with disc orifices 302. Once in place, fastening device 500a can be inserted through blade orifices 202 and disc orifices 302. As such, a compatible lock 500b, such as washers, and nuts in various embodiments, for fastening device 500a can be used to attach weighted disc 102 and blades 101 together. Blades 101 can be positioned on a surface of weighted disc 102 that aligns blade orifices 202 with disc orifices 302. Further, fastening device 500a can be used to attach blades 101 and weighted discs 102 together, in one embodiment.

In another embodiment, weighted discs 102 and blades 101 can be permanently attached. In such embodiment, weighted discs 102 and blades 101 can be unibody. As such, weighted discs 102 and blades 101 can be attached through the use of binding materials or methods such as welding, soldering, molding, and/or cementing.

FIG. 5B illustrates an embodiment of mower blade shaft 100 comprising a plurality of weighted discs 102 attached to blades 101. In an embodiment where weighted discs 102 can be attached to blades 101, mower blade shaft 100 can further comprise a blade support 501. Blade support 501 can be used to connect mower blade shaft 100 to a rotor system on the motor of a conventional lawnmower, in a preferred embodiment. Blade support 501 can comprise at least two or more wings 502 that are compatible with blades 101. As such in one embodiment, wings 502 can be configured to have similar shape with blades 101. Wings 502 can be extended member of blade support 501. As such, each of said wings comprises one or more support orifices 503. Support orifices 503 can be compatible with blade orifices 203 and disc orifices 302, in one embodiment. In another embodiment, mower blade shaft 100 can further comprise a plurality of orifices 504 that matches support orifices 503. Orifices 504 can be at least two or more orifices placed on either blades 101 or weighted discs 102. Orifices 504 can be compatible with support orifices 503. As such, blade support 501 can be attached to mower blade shaft 100 through affixing support orifices 503 with orifices 504 through fastening device 500a. In one embodiment, blade support 501 can be attached to a portion of a lawn mower such as a shaft, to support the weight of mower blade shaft 100. In such embodiment, blade support 501 can be mated with the shaft of the lawnmower while mower blade shaft 100 can be attached to blade support 501. Blade support 501 can be configured to fit snugly into a shaft, in one embodiment. In another embodiment, blade support 501 can also use a lock mechanism to ensure that blade support 501 is secured onto the lawn mower shaft. In this embodiment, blade support 501 can prevent damage or overdrive of lawn mower from too much momentum.

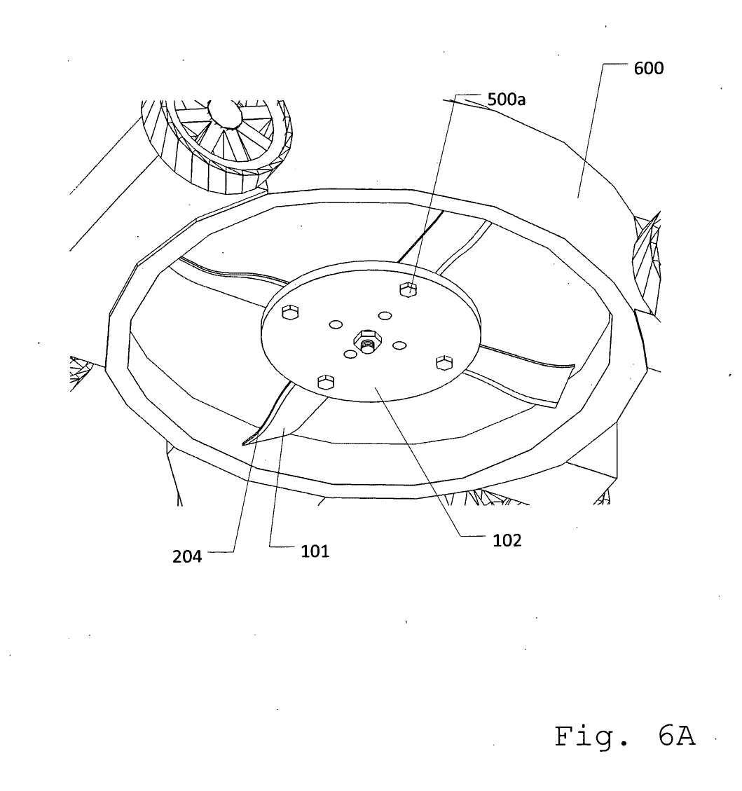

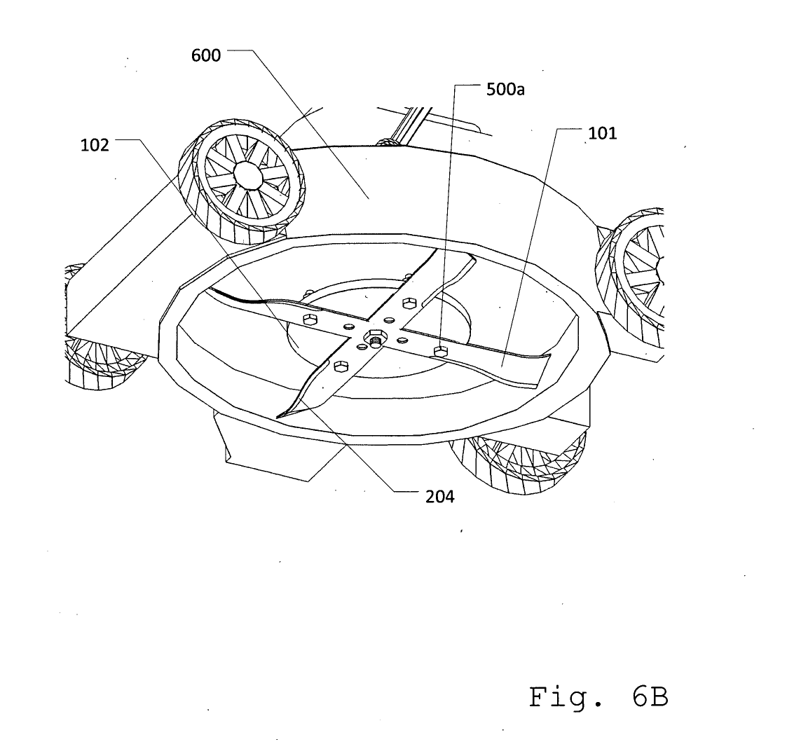

FIG. 6A illustrates mower blade shaft 100 attached at the bottom of a lawn mower 600, wherein weighted disc 102 is at the bottom surface of blades 101. Weighted disc 102 can be attached at the bottom surface of blades 101, wherein cutting edge 204 of blades 101 is kept facing upward. Once blades 101 and weighted disc 102 are attached, mower blade shaft 100 can be mounted under lawn mower 600. As such, base insert 201 of blades 101 and central orifice 301 of weighted disc 102 can be mateable with a shaft of lawn mower 600. Once in place, mower blade shaft 100 can be secured in position through fastening device 500a.

FIG. 6B illustrates mower blade shaft 100 attached at the bottom of lawn mower 600, wherein weighted disc 102 is at the top surface of blades 101. In this embodiment, weighted disc 102 can be attached at the top surface of blades 101, wherein cutting edges 204 of blades 101 are kept facing upward. Once attached, mower blade shaft 100 can be insertable to the shaft of lawn mower 600.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. An improved mower blade comprising
one or more weighted discs comprising a central orifice and a plurality of disc orifices; and
one or more blades comprising a base insert and a plurality of blade orifices, said weighted discs attached to one surface of said blades, further wherein said blade orifices compatible with said disc orifices.

2. The mower blade of claim 1 wherein said blades are permanently attached together.

3. The mower blade of claim 2, wherein said blades are unibody.

4. The mower blade of claim 1 wherein said blades are separate devices, wherein each of said blades are individually mounted to said weighted discs.

5. The mower blade of claim 1 wherein said weighted discs are permanently attached to said blades.

6. The mower blade of claim 1 further comprising a fastener, wherein said fastener insertable on said blade orifices and disc orifices.

7. The mower blade of claim 1 wherein said weighted discs are stackable.

8. The mower blade of claim 1 wherein said blades are attached to said weighted discs in an X-shape.

9. The mower blade of claim 1 wherein said blades are attached to said weighted discs in a Y-shape.

10. The mower blade of claim 1 wherein said blades are attached to said weighted discs in an I-shape.

11. The mower blade of claim 1 wherein said central orifice and said base inserts are mateable with a shaft of a lawn mower.

12. The mower blade of claim 11 further comprising blade support, said blade support mounts to said shaft of said lawn mower, further wherein said blade support comprises at least two or more wings, said wings configured to have similar shape with said blades.

13. The mower blade of claim 1 wherein said surface is top surface of said blades.

14. The mower blade of claim 1 wherein said surface is bottom surface of said blades.

15. The mower blade of claim 1 further comprising a blade support, said blade support mountable to a lawnmower, said blade support connects said blades to said lawnmower.

16. A method for optimizing a lawnmower blade comprising
attaching a weighted disc, said weighted disc comprising a central orifice and a plurality of disc orifices;
affixing said weighted disc to a surface of a blade, said blade comprising a base insert and a plurality of blade orifices, said blade orifices compatible with said disc orifices.
